(19) United States
(12) Patent Application Publication
(10) Pub. No.: US 2017/0180281 A1
(43) Pub. Date: Jun. 22, 2017

(54) PROVIDING TASK ORIENTED ORGANIZATION OF COMMUNICATIONS

(71) Applicant: MICROSOFT TECHNOLOGY LICENSING, LLC, Redmond, WA (US)

(72) Inventors: Vignesh Sachidanandam, Seattle, WA (US); Ned Bearer Friend, Seattle, WA (US); Avneesh Kohli, Bellevue, WA (US); Ashwini Purohit, Seattle, WA (US); March Rogers, Bellevue, WA (US); Hiroshi Tsukahara, Bellevue, WA (US); Tali Roth, Seattle, WA (US); Sohail Tariq, Redmond, WA (US); Den Delimarschi, Redmond, WA (US); Julia Foran, Seattle, WA (US); Stefani Bartz, Redmond, WA (US)

(21) Appl. No.: 14/975,883

(22) Filed: Dec. 21, 2015

(51) Int. Cl. H04L 12/58; G06F 17/24; G06F 17/27; G06F 3/0484

(52) U.S. Cl. CPC H04L 51/046; G06F 3/0484; G06F 17/241; G06F 17/2705

(57) ABSTRACT

Task oriented organization of communications is provided. A communication application initiates operations to organize communications in response to received communications. The communications are analyzed to parse a shared task information. A communication is created from the communications automatically based on a shared task or manually based on a user input. The communication group integrates the shared task information. Next, the communication group is presented with the shared task information.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications facilitate communications.

Conventional email application inboxes are a static list of received messages. Even if they allow grouping or tagging of listed messages, the use scenarios for users are typically limited to viewing a summary of received messages. The amount of email—and extracting relevant information from the email—may thus be overwhelming to the average user. Mails may get lost in the list, or relevant information contained within an email may be hidden and forgotten about.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to task oriented organization of communications. In some examples, a communication application may receive communications. The communications may be analyzed to parse a shared task information. A communication group may be created from the communications. The communication group may also integrate the shared task information. Next, the communication group may be presented with the shared task information.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing task oriented organization of communications, according to embodiments;

FIG. 2 is a display diagram illustrating an example of generating a communication group from communications, according to embodiments:

FIG. 3 is a display diagram illustrating an example of providing shared task information, according to embodiments;

FIG. 4 is a display diagram illustrating an example of annotating a communication, according to embodiments;

FIG. 5 is a display diagram illustrating an example of providing a promotion based communication view, according to embodiments;

FIG. 6 is a simplified networked environment, where a system according to embodiments may be implemented;

FIG. 7 is a block diagram of an example computing device, which may be used to provide task oriented organization of communications, according to embodiments; and

FIG. 8 is a logic flow diagram illustrating a process for providing task oriented organization of communications, according to embodiments.

### DETAILED DESCRIPTION

As briefly described above, task oriented organization of communications may be provided by a communication application. The communication application may include an email processing application, a messaging application, and/or a conferencing application, among others. In an example scenario, the communication application may receive communications. The communications may be analyzed to parse a shared task information. The shared task information may include a topic, a time, and/or a location of a shared task.

A communication group may be created from the communications. The communication group may be created in response to a user action to combine the communications. The communication group may also be created automatically based on an identification of a shared task within the communications. Furthermore, the communication group may also integrate the shared task information. Next, the communication group may be presented with the shared task information. The communications may be provided with collapse control elements to minimize or maximize display of content.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide task oriented organization of communications. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

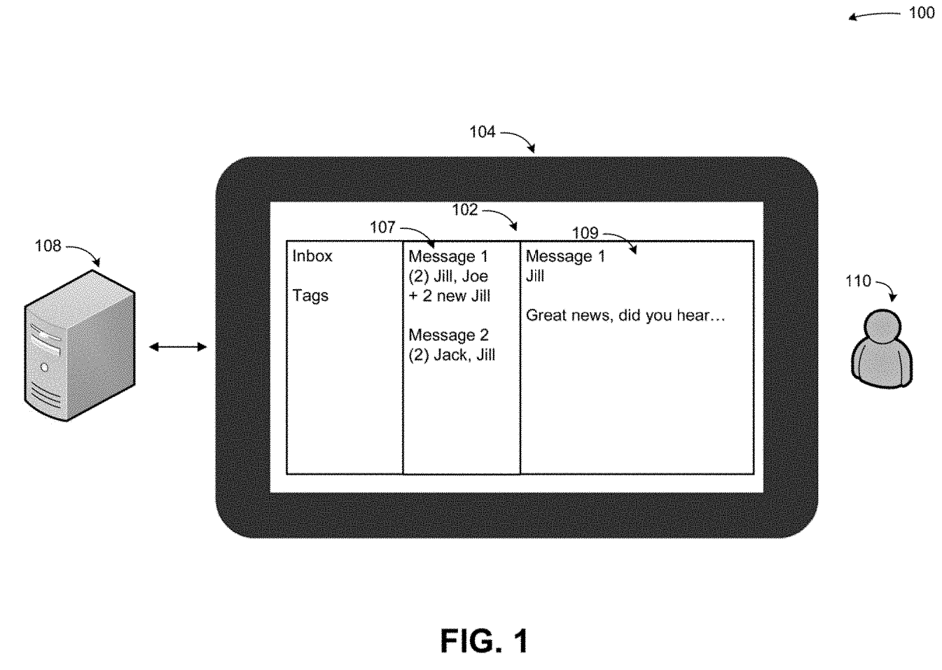

FIG. 1 is a conceptual diagram illustrating an example of providing task oriented organization of communications, according to embodiments.

In a diagram 100, a computing device 104 may execute a communication application 102. Examples of the communication application 102 may include an email processing application, a messaging application, and/or a conferencing application, among others. The computing device 104 may include a tablet device, a laptop computer, a desktop computer, and a smart phone, among others. The computing device 104 may include a special purpose computing device configured to provide communications management through a display component configured to display communications, a communication component configured to transmit communications, and/or a storage component configured to store communications, among other components.

The computing device 104 may display the communication application 102 to a user 110. The user 110 may interact with other users through a communication 109. The user 110 may be allowed to interact with the communication application 102 through an input device or touch enabled display component of the computing device 104. The computing device 104 may also include a display device such as the touch enabled display component, and a monitor, among others to provide the communication application 102 to the user 110.

A rendering module of the communication application 102 may present a communication list 107 of communications between the user 110 and other users. The rendering module may also display the communication 109 in a reading user interface (UI). The communication 109 may include an email, a message, a video conference, and/or an audio conference, among others.

A classification module of the communication application 102 may receive the communication 109 and other communication(s). The communication 109 and the other communication(s) may be analyzed to parse a shared task information. The shared task information may include a topic, a time, and/or a location of a shared task.

The classification module may create a communication group from the communication 109 and the other communication(s). The communication group may be created in response to an action by the user 110 to combine the communication 109 and the other communication(s). The communication group may also be created automatically based on a shared task between the communication 109 and the other communication(s). Furthermore, the communication group may integrate the shared task information. The rendering module of the communication application 102 may present the communication group with the shared task information.

The communication 109 may be stored and managed locally within the computing device 104. Alternatively, the communication 109 may be retrieved from a server 108. The server 108 may include a content server and/or a communication server, among others. The server 108 may also host and manage communications. An example of the server 108 may include an email server that provides communications to be presented by the communication application 102. Additionally, the computing device 104 may communicate with the server 108 through a network. The network may provide wired or wireless communications between nodes such as the computing device 104, or the server 108, among others.

Alternatively, the server 108 may provide the communication application 102. The computing device 104 may present a client interface of the communication application 102. The server 108 may execute operations to provide task oriented organization of communications through the communication application 104.

The user 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the communication application 102, embodiments are not limited to these components or system configurations and can be implemented with other system configuration employing fewer or additional components.

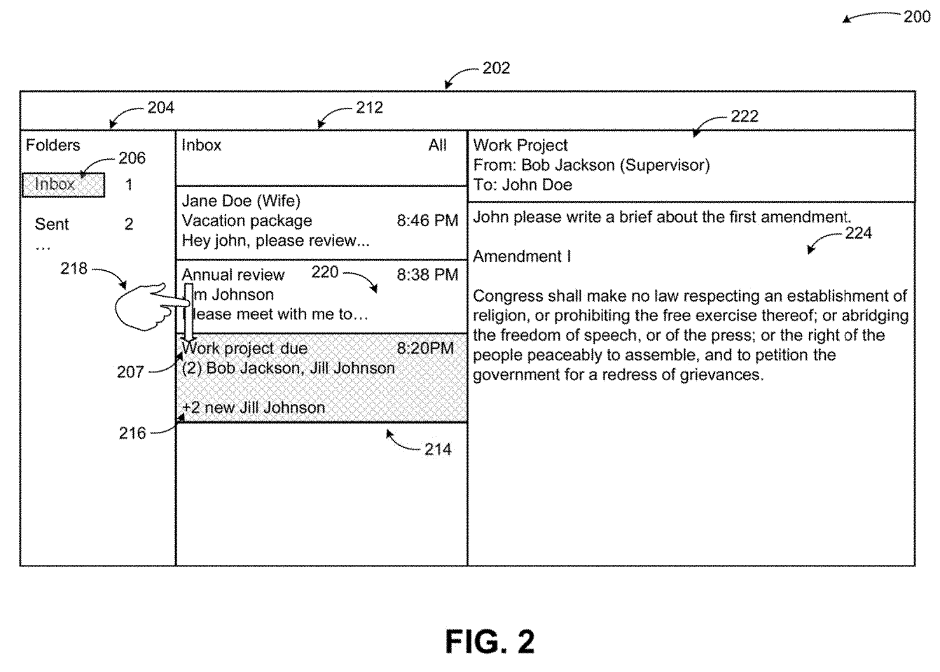

FIG. 2 is a display diagram illustrating an example of generating a communication group from communications, according to embodiments.

In a diagram 200, a communication application 202 may create a communication group 214 from communications. The communications may be analyze to parse a shared task information 207. The shared task information 207 may be integrated into the communication group 214 for a presentation.

In an example scenario, a rendering module of the communication application 202 may present a navigation UI 204 to present navigation elements associated with communications. The navigation elements may include operations to access containers of the communication such as an inbox 206. Communications associated with the containers may be displayed in a communication list 212. The communication list 212 may provide condensed versions of the communications. The condensed communications may include a sender, a subject, and a content representation of the communication.

A classification module of the communication application 202 may create the communication group from communications. Communications may be analyzed to parse a shared task information 207. The shared task information 207 may include a time, a location, and/or a topic of a shared task identified within the communications. The communication group 214 may also be integrated with the shared task information 207.

The communications may be combined automatically or based on a manual input by a user. The classification module may combine the communications into the communication group 214 in response to a user input to package the communications. The classification module may also receive a new communication 220. Furthermore, in response to a user input 218 to insert the new communication 220 into the communication group 214, the new communication 220 may be inserted into the communication group 214. An update to the shared task information 207 may also be identified within the new communication 220. The update may be applied to the shared task information 207.

Control elements may also be provided to access the communications within the communication group 214. The control elements may include operations to expand or collapse a content of the communications within the communication group 214.

Alternatively, the classification module may combine communications automatically based on a shared task identified within the communications. The shared task may be parsed to generate the task information 207. The shared task may also be identified within the new communication 220. The new communication 220 may be parsed to generate an update to the shared task information 207. The shared task information may be updated while combining the new communication 220 and the communication group 214.

The communications within the communication group 214 may also be analyzed to generate an indicator 216. The communications with an unread status may be counted to generate a counter. The counter may be provided in the indicator 216. The indicator 216 may also include users of the communications in the communication group 214.

The rendering module of the communication application 202 may present the communication group 214. The rendering module may also present a communication of the communication group 214 in a reading UI 222. The reading UI 222 may display a subject, a receiver, and/or a sender of the communication. In addition, sorting elements may be presented to allow a user to order the communications within the communication group 214 based on criteria associated with the communications, the shared task, and/or as provided by the user.

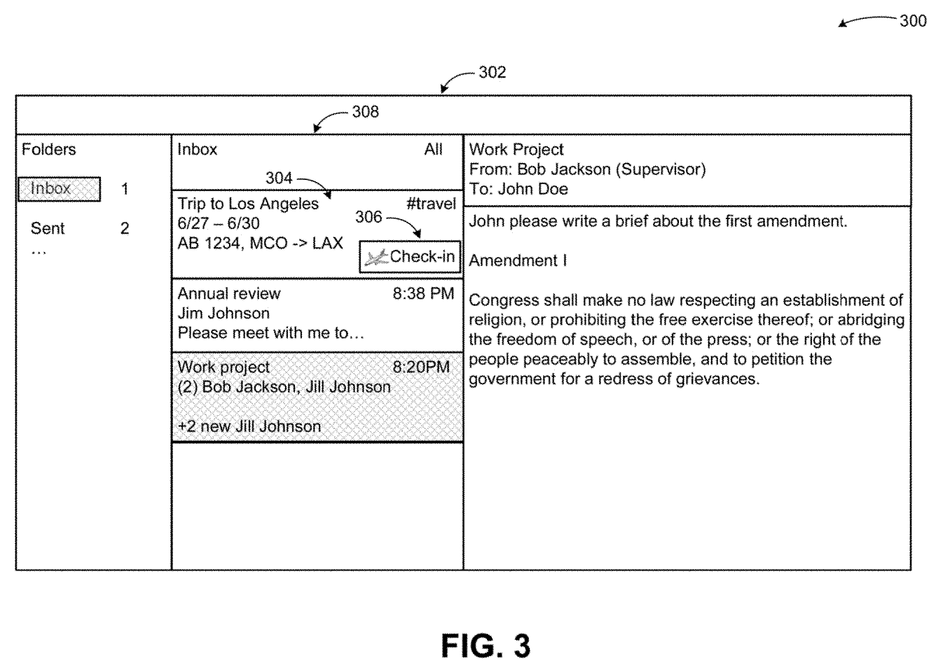

FIG. 3 is a display diagram illustrating an example of providing shared task information, according to embodiments.

In a diagram 300, a communication application 302 may provide a trip 304 as a shared task information associated with communications. Communications may be parsed to detect the trip 304. The communications may be combined to a communication group based on the trip 304. The trip 304 may also be presented to inform a user of trip information detected in the communications.

The trip information may include an origin location, a destination location, a travel time, a travel duration, a travel mode, a travel reservation, and/or a status associated with the travel reservation. Furthermore, a classification module of the communication application may receive a new communication. The new communication may include shared task information associated with the trip 304. Next, the new communication may be parsed to capture an update to the trip. The update may be applied to the trip information.

A control element 306 may also be generated to access an external source associated with the trip 304. The control element 306 may include operations to authorize the user to the external source and transmit the trip information and instructions to the external source to modify and confirm the trip 304. The control element 306 may be displayed by a rendering module of the communication application 302 in response to detected deadlines associated with the trip. For example, the rendering module may display the control element 306 in response to a detection of a 24-hour reminder to check-in to the trip 304. The trip 304 is not provided as a limitation to shared tasks. Other shared tasks may be presented in a communication list 308 to distinguish a shared task described by communication(s).

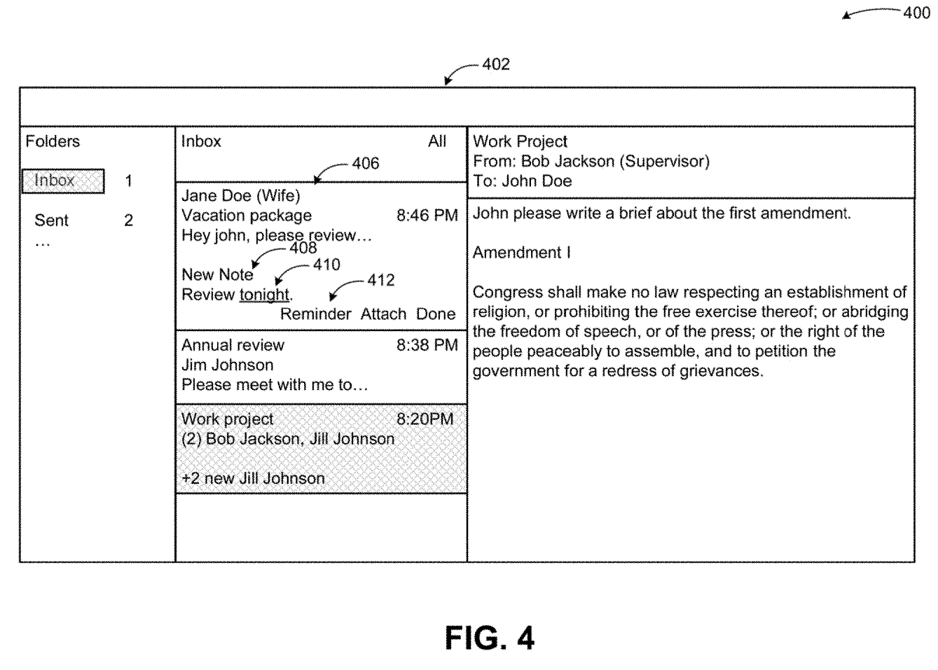

FIG. 4 is a display diagram illustrating an example of annotating a communication, according to embodiments.

In a diagram 400, a communication application 402 may detect a user input to create an annotation 408 associated with a communication. Other annotation(s) may be created in association with other communication(s) or a communication group. A classification module of the communication application 402 may capture the user input as the annotation 408. The annotation 408 may be inserted into the communication 406. The annotation may be presented by a rendering module of the communication application 402.

A time referral 410 associated with a task information of a task (parsed from the communication 406) may be detected within the annotation 408. For example, the time referral may correlate to a deadline associated with the task. The task information may also include a shared task information in a scenario with a communication group. The time referral 410 may be distinguished with a highlighting scheme by a rendering module of the communication application 402. The highlighting scheme may be used to alert a user of the time referral 410.

A reminder element 412 may also be provided in proximity to the annotation 408. The reminder element 412 may include operations to generate a reminder associated with the annotation 408 and the task information. An attachment element may also be provided to attach document(s) to the annotation 408.

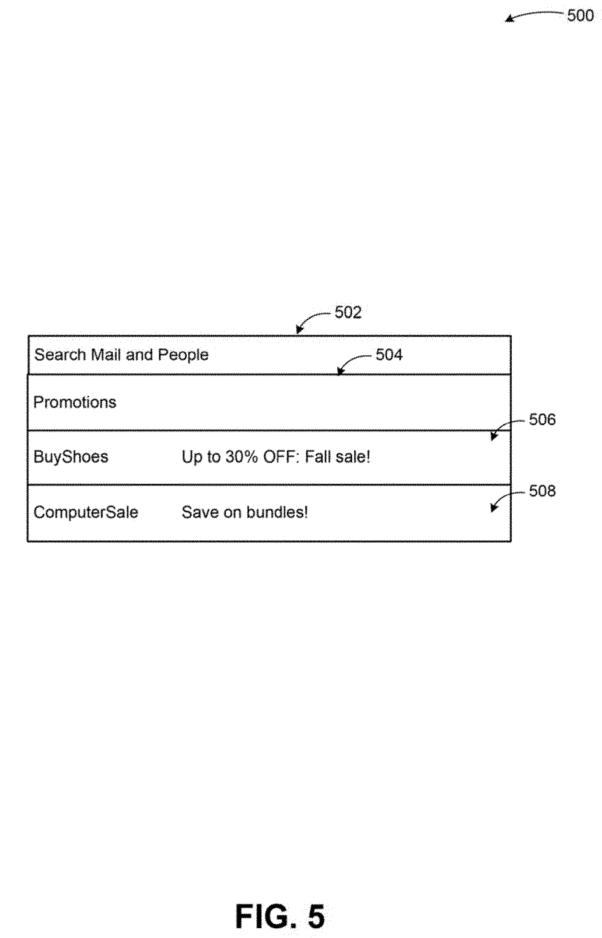

FIG. 5 is a display diagram illustrating an example of providing a promotion based communication view, according to embodiments.

In a diagram 500, a communication application 502 may provide a promotion view 504 to present promotions (506 and 508) detected in communications or in a communication group. The communications may be analyzed by a classification module of the communication application 502 to detect the promotions (506 and 508). Promotion information may be parsed from the promotions (506 and 508) that are detected. The promotion information may include a subject, a time, and/or a topic, among others associated with the promotions (506 and 508).

Promotions (506 and 508) may be presented with the promotion information. Control elements to access communication(s) associated with the promotions (506 and 508) may also be provided. Furthermore, other control elements may be provided to access a sale site of a vendor associated with the promotions (506 and 508).

In some examples, accomplishments or milestones associated with a shared task detected within communication(s) may be celebrated. The classification module may generate feedback to recognize the accomplishments or milestones. The feedback may be displayed to the user or transmitted to other users through a new communication.

As discussed above, the application may be employed to perform operations to automate task oriented organization of communications. An increased user efficiency with the communication application 102 may occur as a result of organizing communications into a communication group based on a shared task information of a shared task between the communications. Additionally, presenting communications with a shared task as a communication group through the communication application 102 may reduce processor load, increase processing speed, conserve memory, and reduce network bandwidth usage.

Embodiments, as described herein, address a need that arises from a lack of efficiency between the users interacting through communication applications executed on various computing devices. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing task oriented organization of communications may be implemented in configurations employing fewer or additional components in applications and user interfaces. Furthermore, the example schema and components shown in FIG. 1 through 5 and their subcomponents may be implemented in a similar manner with other values using the principles described herein.

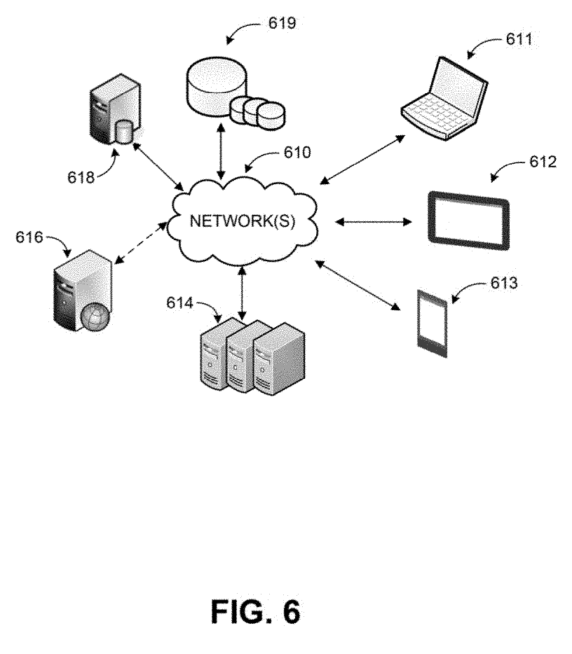

FIG. 6 is an example networked environment, where embodiments may be implemented. A communication application configured to provide task oriented organization of communications may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A communication application may analyze received communications to parse a shared task information. A communication group may be created from the communications. The communication group may also be integrated with the shared task information. Next, the communication group may be presented with the shared task information. The communication application may store data associated with the communication in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide task oriented organization of communications. Furthermore, the networked environments discussed in FIG. 6 are for illustration purposes only. Embodiments are not limited to the example applications, modules, or processes.

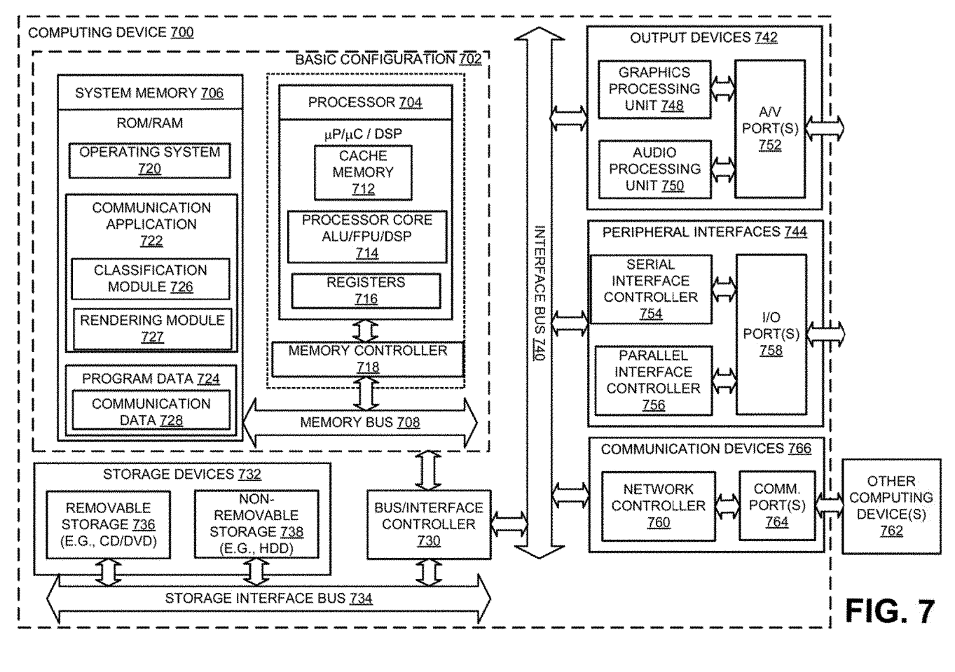

FIG. 7 is a block diagram of an example computing device, which may be used to provide task oriented organization of communications, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a communication application 722, and a program data 724. The communication application 722 may include components such as a classification module 726 and a rendering module 727. The classification module 726 and the rendering module 727 may execute the processes associated with the communication application 722. The classification module 726 may analyze received communications to parse a shared task information. A communication group may be created from the communications. The communication group may also integrate the shared task information. Next, the rendering module 727 may present the communication group with the shared task information.

Components of the communication application 722 (such as a user interface) may also be displayed on a display device associated with the computing device 700. An example of the display device may include a hardware screen that may be communicatively coupled to the computing device 700. The display device may include a touch based device that detects gestures such as a touch action. The display device may also provide feedback in response to detected gestures (or any other form of input) by transforming a user interface of the communication application 722, displayed by the touch based device. The program data 724 may also include, among other data, communication data 728, or the like, as described herein. The communication data 728 may include a communication, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to provide task oriented organization of communications. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

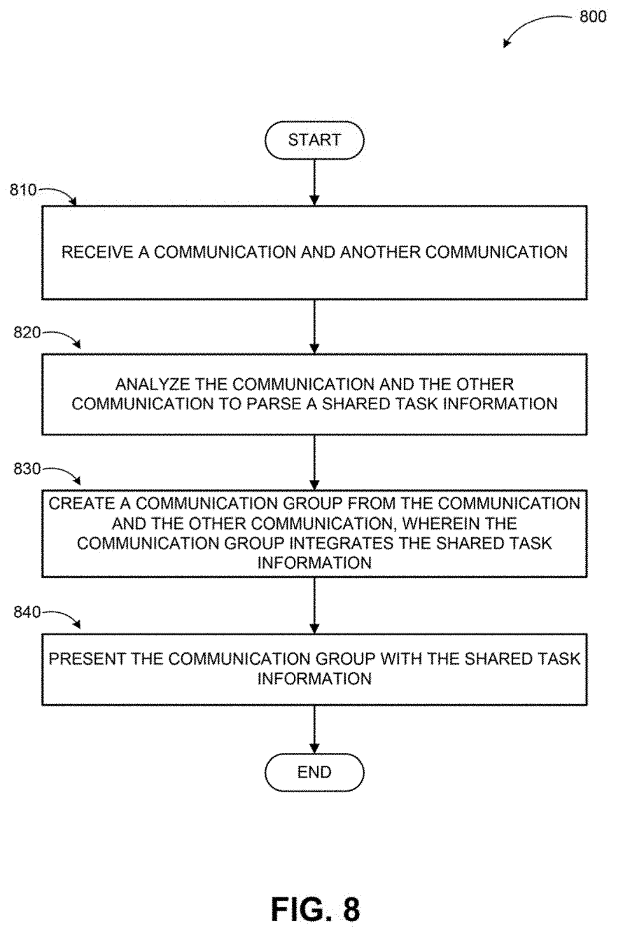

FIG. 8 is a logic flow diagram illustrating a process for providing task oriented organization of communications, according to embodiments. Process 800 may be implemented on a computing device, such as the computing device 700 or another system.

Process 800 begins with operation 810, where a communication application may receive communications. At operation 820, the communications may be analyzed to parse a shared task information. The shared task information may include a topic, a time, and/or a location of a shared task.

At operation 830, a communication group may be created from the communications. The communication group may be created in response to a user action to combine the communications. The communication group may also be created automatically based on an identification of a shared task within the communications. Furthermore, the communication group may also be integrated with the shared task information. Next, at operation 840, the communication group may be presented with the shared task information. The communications may be provided with collapse control elements to minimize or maximize display of content.

The operations included in process 800 are for illustration purposes. Providing task oriented organization of communications may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device for providing task oriented organization of communications is described. The computing device includes a display device, a memory configured to store instructions associated with a communication application, and one or more processors coupled to the memory and the display device. The one or more processors execute the communication application in conjunction with the instructions stored in the memory. The communication application includes a classification module and a rendering module. The classification module is configured to receive a communication and another communication, analyze the communication and the other communication to parse a shared task information, and create a communication group from the communication and the other communication, wherein the communication group integrates the shared task information. The rendering module is configured to present, on the display device, the communication group with the shared task information.

In other examples, the classification module is further configured to detect a user input to package the communication and the other communication and combine the communication and the other communication into the group. The classification module is further configured to receive a new communication, detect a user input to insert the new communication into the communication group, identify an update to the shared task information within the new communication, and combine the new communication and the communication group, wherein the update is applied to the shared task information.

In further examples, the classification modules is further configured to identify a shared task within the communication and the other communication, parse the shared task to generate the task information, wherein the shared task information includes one or more of: a topic of the shared task, a time of the shared task and a location of the shared task, receive a new communication, identify the shared task within the new communication, parse the shared task within the new communication to generate an update to the shared task information, and combine the new communication and the communication group, wherein the update is applied to the shared task information.

In other examples, the classification module is further configured to detect an unread status associated with one or more of the communication and the other communication and generate an indicator with a counter, wherein the counter includes a number of one or more of the communication and the other communication with the unread status. The rendering module is further configured to present, on the display device, the indicator with the counter within the communication group.

In further examples, the classification module is further configured to detect the shared task information as a trip and identify trip information associated with the trip, wherein the trip information includes one or more of an origin location, a destination location, a travel time, a travel duration, a travel mode, a travel reservation, and a status associated with the travel reservation. The rendering module is further configured to present, on the display device, the trip information. The classification module is further configured to generate a control element to access an external source associated with the trip information, wherein the external source provides additional elements to modify and confirm the trip and provide the control element to the rendering module for a presentation. The rendering module is further configured to provide sorting elements to reorder one or more of the communication and the other communication within the communication group.

In some examples, a method executed on a computing device for providing task oriented organization of communications. The method includes receiving a communication and another communication, analyzing the communication and the other communication to parse a shared task information, wherein the shared task information includes one or more of a topic, a time, and a location of a shared task, creating a communication group from the communication and the other communication, wherein the communication group integrates the shared task information, and presenting the communication group with the shared task information.

In other examples, the method further includes detecting a user input to create an annotation associated with the communication, capturing the user input as the annotation, and inserting the annotation into the communication. The method further includes detecting a time referral within the annotation, wherein the time referral is associated with the shared task information and distinguishing the time referral with a highlighting scheme. The method further includes providing one or more reminder elements in proximity to the annotation, wherein the one or more reminder elements include operations to generate a reminder associated with one or more of the annotation and the task information.

In further examples, the method further includes analyzing the communication and the other communications to detect one or more promotions, parsing promotion information from the one or more promotions, wherein the promotion information includes one or more of a subject, a time, and a topic associated with the one or more promotions, presenting the one or more promotions with the promotion information, and providing one or more control elements to access one or more of the communication and the other communication associated with the one or more promotions.

In some examples, a computer-readable memory device with instructions stored thereon for providing task oriented organization of communications is described. The instructions include actions that are similar to the actions of the method.

In some examples, a means for providing task oriented organization of communications is described. The means for providing task oriented organization of communications includes a means for receiving a communication and another communication, a means for analyzing the communication and the other communication to parse a shared task information, a means for creating a communication group from the communication and the other communication, wherein the communication group integrates the shared task information, and a means for presenting the communication group with the shared task information.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing task oriented organization of communications, the computing device comprising:
a display device;
a memory configured to store instructions associated with a communication application;
one or more processors coupled to the memory and the display device, the one or more processors executing the communication application in conjunction with the instructions stored in the memory, wherein the communication application includes:
a classification module configured to:
receive a communication and another communication;
analyze the communication and the other communication to parse a shared task information;
create a communication group from the communication and the other communication, wherein the communication group integrates the shared task information;
a rendering module configured to:
present, on the display device, the communication group with the shared task information.

2. The computing device of claim 1, wherein the classification module is further configured to:
detect a user input to package the communication and the other communication; and
combine the communication and the other communication into the group.

3. The computing device of claim 1, wherein the classification module is further configured to:
receive a new communication;
detect a user input to insert the new communication into the communication group;
identify an update to the shared task information within the new communication; and
combine the new communication and the communication group, wherein the update is applied to the shared task information.

4. The computing device of claim 1, wherein the classification module is further configured to:
identify a shared task within the communication and the other communication; and
parse the shared task to generate the shared task information, wherein the shared task information includes one or more of: a topic of the shared task, a time of the shared task and a location of the shared task.

5. The computing device of claim 4, wherein the classification module is further configured to:
receive a new communication;
identify the shared task within the new communication;
parse the shared task within the new communication to generate an update to the shared task information; and
combine the new communication and the communication group, wherein the update is applied to the shared task information.

6. The computing device of claim 1, wherein the classification module is further configured to:
detect an unread status associated with one or more of the communication and the other communication; and
generate an indicator with a counter, wherein the counter includes a number of one or more of the communication and the other communication with the unread status.

7. The computing device of claim 6, wherein the rendering module is further configured to:
present, on the display device, the indicator with the counter within the communication group.

8. The computing device of claim 1, wherein the classification module is further configured to:
detect the shared task information as a trip; and
identify trip information associated with the trip, wherein the trip information includes one or more of an origin location, a destination location, a travel time, a travel duration, a travel mode, a travel reservation, and a status associated with the travel reservation.

9. The computing device of claim 8, wherein the rendering module is further configured to:
present, on the display device, the trip information.

10. The computing device of claim 8, wherein the classification module is further configured to:
generate a control element to access an external source associated with the trip information, wherein the external source provides additional elements to modify and confirm the trip; and
provide the control element to the rendering module for a presentation.

11. The computing device of claim 1, wherein the rendering module is further configured to:
provide sorting elements to reorder one or more of the communication and the other communication within the communication group.

12. A method executed on a computing device for providing task oriented organization of communications, the method comprising:
receiving a communication and another communication;
analyzing the communication and the other communication to parse a shared task information, wherein the shared task information includes one or more of a topic, a time, and a location of a shared task;
creating a communication group from the communication and the other communication, wherein the communication group integrates the shared task information; and
presenting the communication group with the shared task information.

13. The method of claim 12, further comprising:
detecting a user input to create an annotation associated with the communication;
capturing the user input as the annotation; and
inserting the annotation into the communication.

14. The method of claim 13, further comprising:
detecting a time referral within the annotation, wherein the time referral is associated with the shared task information; and
distinguishing the time referral with a highlighting scheme.

15. The method of claim 13, further comprising:
providing one or more reminder elements in proximity to the annotation, wherein the one or more reminder elements include operations to generate a reminder associated with one or more of the annotation and the task information.

16. The method of claim 12, further comprising:
analyzing the communication and the other communications to detect one or more promotions; and
parsing promotion information from the one or more promotions, wherein the promotion information includes one or more of a subject, a time, and a topic associated with the one or more promotions.

17. The method of claim 16, further comprising:
presenting the one or more promotions with the promotion information; and
providing one or more control elements to access one or more of the communication and the other communication associated with the one or more promotions.

18. A computer-readable memory device with instructions stored thereon for providing task oriented organization of communications, the instructions comprising:
receiving a communication and another communication;
analyzing the communication and the other communication to parse a shared task information, wherein the shared task information includes one or more of a topic, a time, and a location of a shared task;
creating a communication group from the communication and the other communication, wherein the communication group integrates the shared task information; and
presenting the communication group with the shared task information.

19. The computer-readable memory device of claim 18, wherein the instructions further comprise:
receiving a new communication;
detecting a user input to insert the new communication into the group and reorder the group;
identifying an update to the shared task information within the new communication;
combining the new communication and the communication group, wherein the update is applied to the shared task information; and
reordering the communication group based on the user input.

20. The computer-readable memory device of claim 18, wherein the instructions further comprise:
detecting a user input to create an annotation to the communication;
capturing the user input as the annotation;
inserting the annotation into the communication;
detecting a time referral associated with the task information within the annotation; and
distinguishing the time referral with a highlighting scheme.
